(19) United States
(12) Patent Application Publication
(10) Pub. No.: US 2009/0115312 A1
(43) Pub. Date: May 7, 2009

(54) ELECTRONIC DEVICE HAVING LUMINESCENCE SURFACE AND MANUFACTURING METHOD OF THE HOUSING FOR THE SAME

(75) Inventor: Tsai-Jung Hu, Pingjhen City (TW)

Correspondence Address: SNELL & WILMER L.L.P. (Main), 400 EAST VAN BUREN, ONE ARIZONA CENTER, PHOENIX, AZ, 85004-2202, US

(73) Assignee: DARFON ELECTRONICS CORP., Gueishan (TW)

(21) Appl. No.: 12/265,087

(22) Filed: Nov. 5, 2008

(30) Foreign Application Priority Data
Nov. 7, 2007 (TW) 96141982

(51) Int. Cl. H01J 1/62

(52) U.S. Cl. 313/498; 264/104

(57) ABSTRACT

A manufacturing method of a housing having a luminescence surface for an electronic device is provided. The method includes the steps of providing an electroluminescent film; providing a molding device including an upper mold and a lower mold; conformally attaching the electroluminescent film to the upper mold and forming a predetermined space between the electroluminescent film and the lower mold; injecting a plastic material into the predetermined space by an in-mold decoration (IMD) injection molding process; and solidifying the plastic material to form the housing, such that the electroluminescent film is on a surface of the housing. The present invention also provides an electronic device including a body; a housing covering the body; and an electroluminescent film on a surface of the housing formed by an IMD injection molding process.

### CROSS REFERENCE TO RELATED APPLICATIONS

This application claims the right of priority based on Taiwan Patent Application No. 96141982 entitled “Electronic Device Having Luminescence Surface and Manufacturing Method of the Housing for the same” filed on Nov. 7, 2008, which is incorporated herein by reference and assigned to the assignee herein.

### FIELD OF THE INVENTION

This invention relates to a device and manufacturing methods thereof by an in-mold decoration (IMD) injection molding process, and more particularly relates to an electronic device having an electroluminescent film and manufacturing methods of the same.

### BACKGROUND OF THE INVENTION

The conventional in-mold decoration injection (IMD) molding process, integrating the techniques of ink printing, pre-forming, trimming and resin injection with certain films made of specific materials, has developed a variety of consumer electronic devices, especially for appearance designs in mobiles phones or the panels of various instruments. However, the films being processed by the conventional IMD art are normally unable to emit light, and thus the varieties of the resulted products are limited. Therefore, it is desired to provide an electronic device having a luminescence surface and the manufacturing methods for the same by way of the IMD injection molding process.

### SUMMARY OF THE INVENTION

In light of the foregoing, it is one object of the present invention to provide an. electronic device having a luminescence surface and the manufacturing methods for the same. Taking the advantage of the luminescence surface, the electronic device of the present invention is available to operate at places under dusky light or in absence of light sources. The present invention also enlarges the application field of the IMD injection molding process and solves the problems or drawbacks of the prior art.

One aspect of the present invention is to provide a manufacturing method of a housing having a luminescence surface for an electronic device. The method comprising the steps of providing an electroluminescent film; providing a molding device including an upper mold and an lower mold; conformally attaching the electroluminescent film to the upper mold and forming a predetermined space between the electroluminescent film and the lower mold; injecting a plastic material into the predetermined space by an in-mold decoration injection molding process; and solidifying the plastic material to form the housing, such that electroluminescent film is located on a surface of the housing.

Another aspect of the present invention is to provide an electronic device having a luminescent surface. The electronic device comprises a body; a housing covering the body; and an electroluminescent film on a surface of the housing, wherein the electroluminescent film is formed by an in-mold decoration injection molding process.

By way of the abovementioned aspects, the present invention provides light emitting products having various constructions and configurations with diverse decorations. The objects and the features of the present invention may best be understood by reference to the detailed description.

### BRIEF DESCRIPTION OF THE DRAWINGS

FIG. 1 is a flow chart showing the manufacturing steps of a housing having a luminescent surface for an electronic device in accordance with the present invention.

FIG. 2 is a cross-sectional view illustrating the structure of an electroluminescent film in accordance with the present invention.

FIG. 3 is a cross-sectional view illustrating a molding device in accordance with the present invention.

FIG. 4A and FIG. 4B are cross-sectional views illustrating the steps of molding the electroluminescent film in accordance with the present invention.

FIG. 5 and FIG. 6 are cross-sectional views illustrating the steps for manufacturing a housing in accordance with the present invention.

FIG. 7 is a cross-sectional view illustrating a housing in accordance with the present invention.

FIG. 8 illustrates a computer mouse having an electroluminescent film in accordance with a first embodiment of the present invention.

FIG. 9 illustrates a button key having an electroluminescent film in accordance with a second embodiment of the present invention.

FIG. 10 illustrates a mobile phone key having an electroluminescent film in accordance with a third embodiment of the present invention.

FIG. 11 illustrates a ring-typed luminescent lamp having an electroluminescent film in accordance with a fourth embodiment of the present invention.

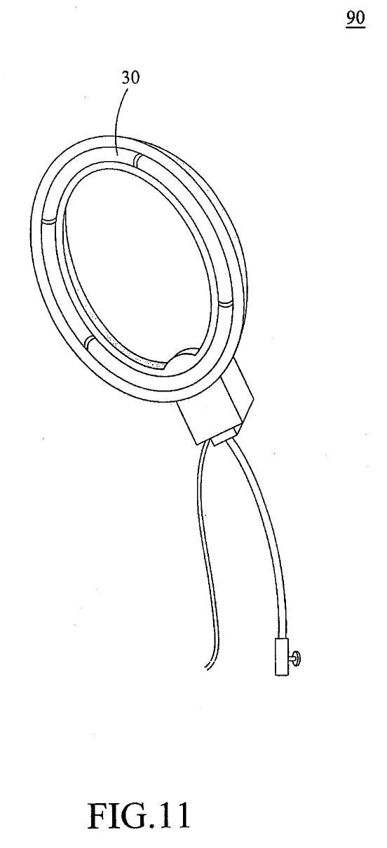

### DETAILED DESCRIPTION OF THE INVENTION

The preferred embodiments of the present invention will now be described in greater details by referring to the drawings that accompany the present application. It should be noted that the features illustrated in the drawings are not necessarily drawn to scale. Descriptions of well-known components, materials, and process techniques are omitted so as to not unnecessarily obscure the embodiments of the invention. Any devices, components, materials, and steps described in the embodiments are only for illustration and not intended to limit the scope of the present invention.

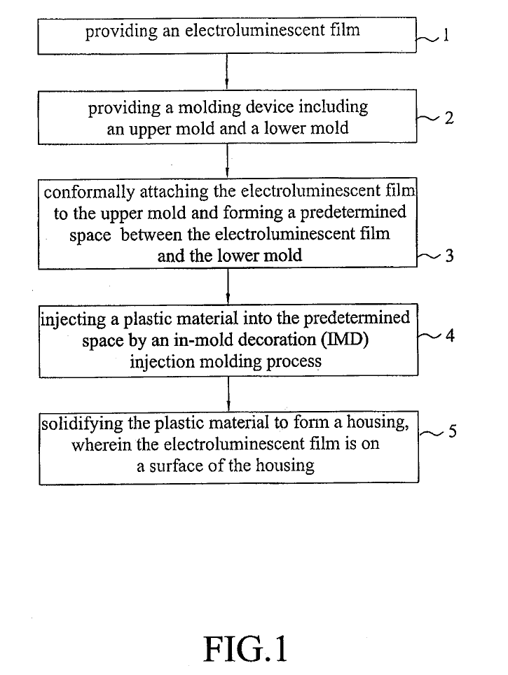

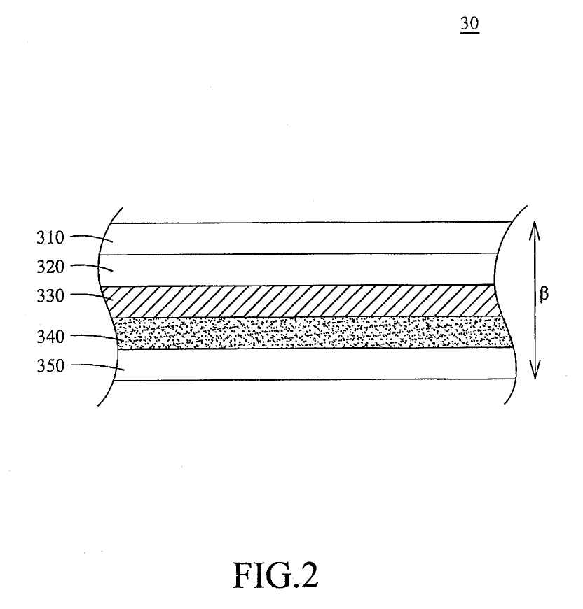

FIG. 1 is a flow chart illustrating the steps of the manufacturing steps of a housing having a luminescent surface for an electronic device in accordance with an embodiment of the present invention. FIG. 1 is better understood accompanying with FIG. 2 to FIG. 7 respectively. As shown in FIG. 1 and FIG. 2, the step 1 is to provide an electroluminescent film 30. The electroluminescent film 30 includes a laminate having a transparent plastic film 310, a first electrode layer 320, a luminescence layer 330, a dielectric layer 340 and a second electrode layer 350 stacked in order. The transparent plastic film 310 can be made of polyethylene terephthalate, polycarbonate, or polypropylene. The compositions of each film or layer of the laminate are well known, for example, as shown in Taiwan Patent No. M248065, which is incorporated herein by reference. The electroluminescent film 30 will emit light when a voltage is applied to and then electrons in the luminescence layer 330 are stimulated. Note that the electroluminescent film 30 is formed with a thickness β.

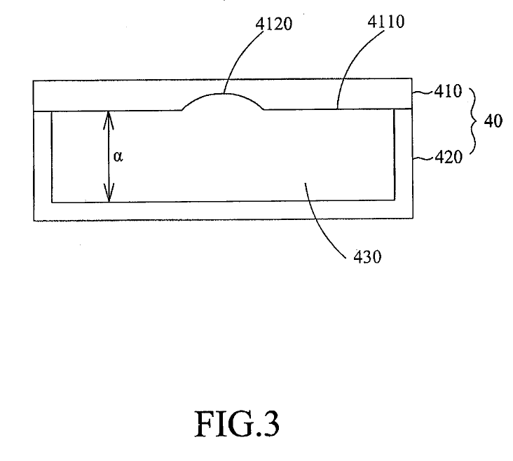

As shown in FIG. 1 and FIG. 3, the step 2 is to provide a molding device 40. The molding device 40 includes an upper mold 410 and a lower mold 420. The upper mold 410 is formed with an inner surface 4110 having an arc-shaped recess 4120. The lower mold 420 is structured as a concave. Note that when the upper mold 410 and the lower mold 420 are engaged, an accommodation room 430 is formed between them. The accommodation room 430 defines a height a greater than the thickness β of the electroluminescent film 30. Note that in the embodiment, the shapes of the upper mold 410 and the lower mold 420 are provided for illustration not limitation. In other words, the shapes of the upper mold 410 and the lower mold 420 can vary depending upon the requirements in design.

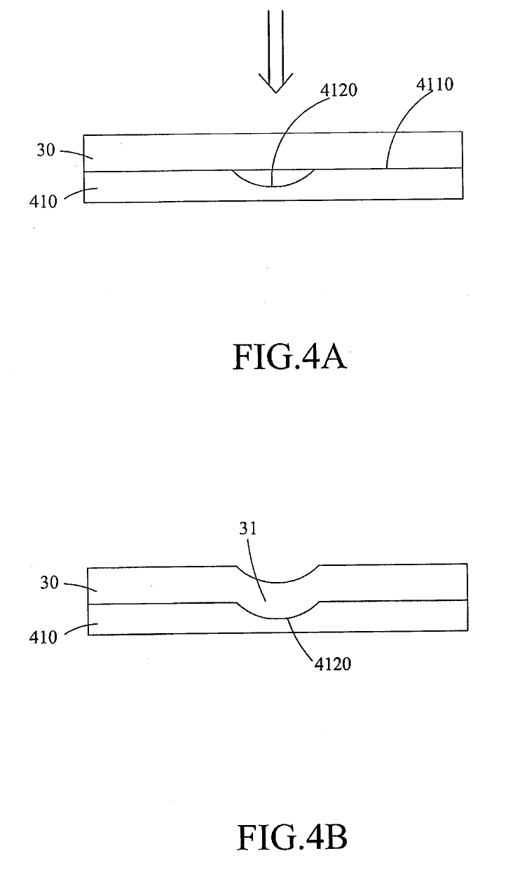

Referring to FIGS. 4A and 4B, the electroluminescent film 30 is placed on the inner surface 4110 of the upper mold 410. Then, by appropriate techniques, the electroluminescent film 30 is forced to conformally attach to the upper mold 410. The appropriate techniques can be a stamping process or a vacuum forming. As a result, the electroluminescent film 30 is molded to form with a portion 31 structured as the arc-shaped recess 4120 of the upper mold 410. Forming the molded electroluminescent film 30 can be referred to the step 3 of FIG. 1.

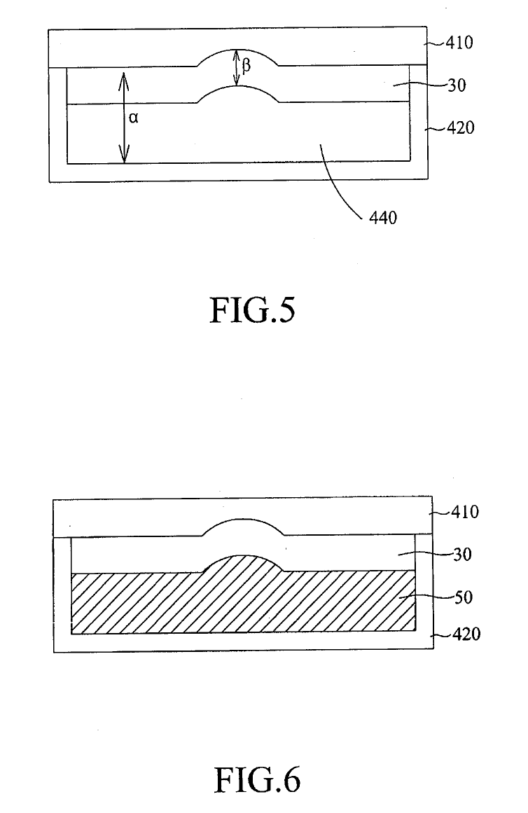

Referring to FIG. 5, the upper mold 410 and the lower mold 420 is engaged after the electroluminescent film 30 is conformally attached to the upper mold 410. As having noted, the height a of the accommodation room 430 is greater than the thickness β of the electroluminescent film 30, such that a predetermined space 440 between the molded electroluminescent film 30 and the lower mod 40 is formed. Forming a predetermined space 440 can also be referred to the step 3 of FIG. 1.

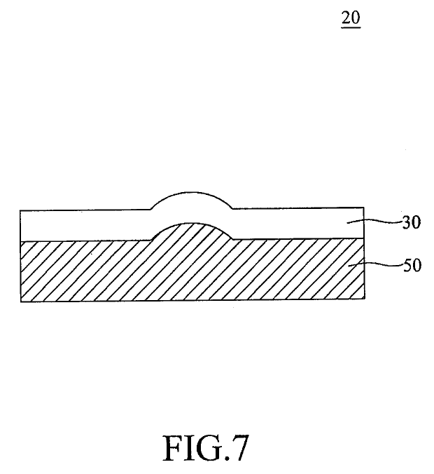

As shown in FIG. 1 and FIG. 6, the step 4 is to inject a plastic material 50 into the predetermined space 440 by an in-mold decoration injection molding process. The plastic material 50 will be solidified during a certain period. Then, after the plastic material 50 is solidified, the upper mold 410 and the lower mold 410 are disengaged and a housing 20 with the surfaced electroluminescent film 30 is formed, as shown in FIG. 7. Note that the housing 20 can vary to be applicable to any kind of electronic devices. Solidifying the plastic material 50 and forming the housing 20 covered with the electroluminescent film 30 can be referred to the step 5 of FIG. 1.

When mass production of the housing 20 is desired, the electroluminescent film 30 in a large size and a large-scaled molding device (not shown) may be required. The large-scaled molding device can be equipped with multiple molding devices 40 in series. For mass production, the large-sized electroluminescent film 30 can be placed within the large-scaled molding device and then the aforementioned steps are preformed to obtain multiple housings connected in series. At this moment, a cutting process can be performed to divide the multiple connected housings into individual ones. As such a manner for mass production, the production rate is enhanced and the cost is reduced.

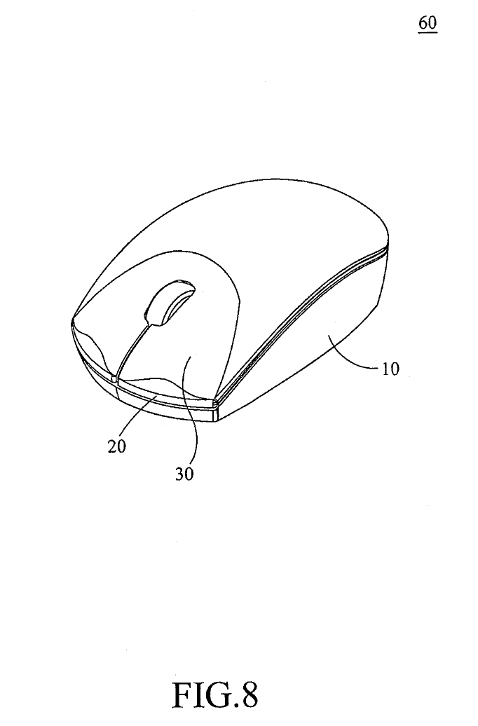

FIG. 8 illustrates a computer mouse 60 including a housing 20 with a light-emitting surface in accordance with the first embodiment of the present invention. As shown in FIG. 8, the computer mouse 60 includes a body 10, a housing 20 covering the body 10, and an electroluminescent film 30 on the surface of the housing 20, which are made by the in-mold decoration injection molding process. As shown in FIG. 8, the electroluminescent film 30 covers the left and right keys of the computer mouse 60. When the computer mouse 60 connects to the computer and is activated, the electroluminescent film 30 can be electronically connected and then emit light. Therefore, the left and right keys of the computer mouse 60 are capable of not only controlling but also brightening. The appearance of the computer mouse 60 is also enhanced.

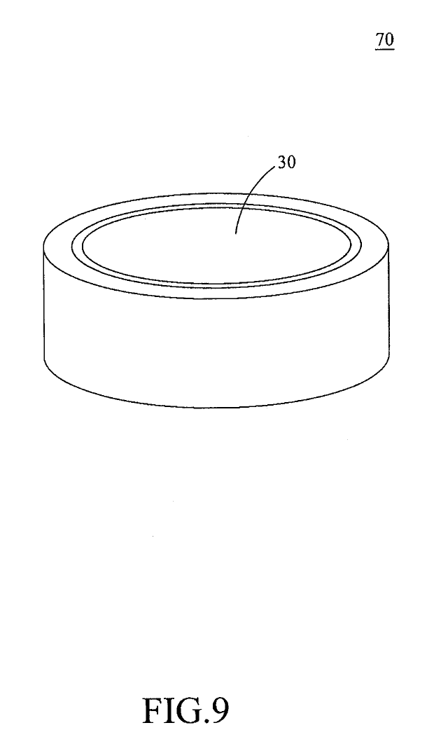

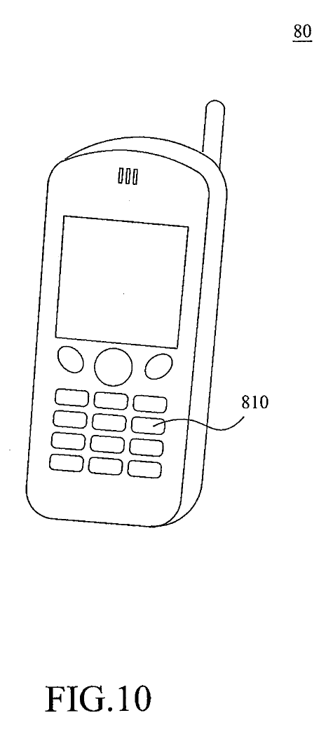

FIG. 9 illustrates a key button 70 in accordance with the second embodiment of the present invention, wherein an electroluminescent film 30 is formed on the top portion of the key button 70 to be pressed by users. The electronic devices with light-emitting surfaces also can be portable. FIG. 10 illustrates a mobile phone 80 in accordance with the third embodiment of the present invention. The mobile phone 80 includes key buttons 810 with the electroluminescent surface. When the mobile phone 80 is operated, the key button 810 will brighten, such that it is more convenient using the mobile phone 80 under dusky light or in absence of light sources. FIG. 10 illustrates a ring-typed luminescent lamp 90 in accordance with the fourth embodiment of the present invention, wherein the electroluminescent film 30 is on the surface of the ring-typed luminescent lamp 90.

Conventional products made by the IMD art are normally unable to emit light, and thus the application fields are limited. Since the present invention integrates the IMD art with the electroluminescent film, electronic devices with luminescent surfaces are created and the application of the IMD products is enlarged as well. Consequently, further developing the IMD products will be fully expected.

Although specific embodiments have been illustrated and described, it will be obvious to those skilled in the art that various modifications may be made without departing from what is intended to limited solely by the appended claims.

1. A manufacturing method of a housing having a luminescence surface for an electronic device, the manufacturing method comprising steps of:
providing an electroluminescent film;
providing a molding device including an upper mold and an lower mold;
conformally attaching the electroluminescent film to the upper mold and forming a predetermined space between the electroluminescent film and the lower mold;
injecting a plastic material into the predetermined space by an in-mold decoration injection molding process; and
solidifying the plastic material to form the housing, such that the electroluminescent film is located on a surface of the housing.

2. The manufacturing method of claim 1, wherein the electroluminescent film comprises a transparent plastic film, a first electrode layer, a luminescence layer, a dielectric layer and a second electrode layer in order.

3. The manufacturing method of claim 2, wherein when the electroluminescent film is conformally attached on the upper mold, and the upper mold directly faces the transparent plastic film.

4. The manufacturing method of claim 2, wherein the transparent plastic film comprises polyethylene terephthalate, polycarbonate, or polypropylene.

5. The manufacturing method of claim 1, wherein the step of conformally attaching the electroluminescent film to the upper mold is performed by a stamping process or a vacuum forming.

6. The manufacturing method of claim 1, further comprising cutting the electroluminescent film.

7. An electronic device having a luminescent surface, the electronic device comprises:
a body;
a housing covering the body; and
an electroluminescent film on a surface of the housing, wherein the electroluminescent film is formed by an in-mold decoration injection molding process.

8. The electronic device of claim 7, wherein the body is a key button.

9. The electronic device of claim 7, wherein the body is a ring-typed lamp.

10. The electronic device of claim 7, wherein the body is a computer mouse.

11. The electronic device of claim 7, wherein the body is a portable electronic device.
